(19) United States
(12) Patent Application Publication
(10) Pub. No.: US 2020/0293973 A1
(43) Pub. Date: Sep. 17, 2020

(54) METHOD AND SYSTEM FOR INCENTIVIZING AND RANKING CUSTOMER SERVICE AGENTS

(71) Applicant: Ryan Phillip Kleinman, San Diego, CA (US)

(72) Inventor: Ryan Phillip Kleinman, San Diego, CA (US)

(21) Appl. No.: 16/354,172

(22) Filed: Mar. 15, 2019

(51) Int. Cl. G06Q 10/06; G06Q 20/02

(52) U.S. Cl. CPC G06Q 10/06398; G06Q 30/016; G06Q 20/027

(57) ABSTRACT

A method and apparatus for incentivizing and ranking customer service agents is provided. The method begins with the completion of a customer service interaction. The customer service agent sends the customer a tip option message inviting the customer to leave a tip if the customer is satisfied with the service. The customer message includes a link to allow the customer to enter a tip amount. Once a tip amount is entered, the customer is redirected to a payment gateway where the customer selects from multiple electronic payment options to leave the tip. The payment gateway reports the tip to the subscribing company, who then records the tip amount in a customer service agent record. The subscribing company may then rank the customer service agents based on the tips received during a pre-selected period of time.

### BACKGROUND

### Field

The present disclosure relates generally to customer service. More specifically the present disclosure relates to methods and systems for incentivizing and ranking customer service agents.

### Background

Customer service agents or representatives are often the first contact a company has with a customer or potential customer. Potential customers may first interact with a customer service agent during a call or on-line chat or order process. How this contact is handled may directly influence future sales. For some businesses, customer service agents serve as a problem-solving point of contact for customers having difficulty with a product or service. Customers with problems are unhappy or angry and how a company addresses those problems can enhance or detract from a company's overall consumer reputation. The advent of applications and platforms providing on-line reviews allows an unhappy consumer a mechanism to vent anger, and in consequence, damage company reputation among a wide audience.

Typically, customer service agents are low paid, often at minimum wage levels, and often work long shifts dealing with angry customers or uninformed consumers. These circumstances may result in agents that do not care about the customer, have no sense of pride or ownership of their work, and do little beyond the minimum needed to resolve a customer service contact.

Poor customer service may decrease company profit and enable competition for the best customers. Marketing strategies may be defeated or ineffective if the positive message is buried beneath an avalanche of bad reviews and poor word-of-mouth commentary. Scenarios like those described above may also result in high employee turnover, which in turn may worsen the level of customer service provided.

Customer service agents may respond to a method that incentivizes providing excellent customer service. Excellent customer service may increase corporate revenues and improve customer loyalty.

There is a need in the art for a method and system for incentivizing and ranking customer service agents.

### SUMMARY

Embodiments described herein provide a method and system for incentivizing and ranking customer service agents. The method begins with the completion of a customer service interaction. The customer service agent sends the customer a tip option message inviting the customer to leave a tip if the customer is satisfied with the service. The customer message includes a link to allow the customer to enter a tip amount. Once a tip amount is entered, the customer is redirected to a payment gateway where the customer selects from multiple electronic payment options to leave the tip. The payment gateway reports the tip to the subscribing company, who then records the tip amount in a customer service agent record. The subscribing company may then rank the customer service agents based on the tips received during a pre-selected period of time.

A further embodiment provides an apparatus for incentivizing and ranking customer service agents. The apparatus provides: means for completing a customer service interaction; means for sending a tip option message to a customer that participated in the customer service interaction; means for receiving a response to the tip option message from the customer; means for redirecting the customer to a payment gateway if a tip amount is entered in the tip option message; means for receiving the tip amount from the payment gateway; means for recording the tip amount in a customer service agent record; and means for ranking customer service agents based on the customer service agent record.

A yet further embodiment provides a non-transitory computer-readable medium containing instructions, which when executed cause a processor to perform the steps of: sending a tip option message to a customer that participated in a completed customer service interaction; receiving a response to the tip option message from the customer; redirecting the customer to a payment gateway if a tip amount is entered in the tip option message; receiving the tip amount from the payment gateway; recording the tip amount in a customer service agent record; and ranking customer service agents based on the customer service agent record.

### BRIEF DESCRIPTION OF THE DRAWINGS

FIG. 1 illustrates the subscriber interfaces for the subscription service, in accordance with embodiments disclosed herein.

FIG. 2 shows the operation of the subscription service, in accordance with embodiments described herein.

FIG. 3 depicts a message sent to a customer after a customer service interaction, in accordance with embodiments described herein.

FIG. 4 shows the manager's or supervisor's dashboard for subscribing companies, in accordance with embodiments described herein.

FIG. 5 illustrates a customer service representative dashboard for subscribing companies, in accordance with embodiments described herein.

FIG. 6 is a flow chart of a method for incentivizing and ranking customer service agents, in accordance with embodiments described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the term “determining” encompasses a wide variety of actions and therefore, “determining” can include calculating, computing, processing, deriving, investigating, looking up (e.g., looking up in a table, a database or another data structure), ascertaining and the like. Also, “determining” can include resolving, selecting choosing, establishing, and the like.

The phrase “based on” does not mean “based only on,” unless expressly specified otherwise. In other words, the phrase “based on” describes both “based only on” and “based at least on.”

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core or any other such configuration.

The steps or blocks of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps, blocks, or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Disk and disc, as used herein, includes compact disk (CD), laser disk, optical disc, digital versatile disk (DVD), floppy disk, and Blu-ray ® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

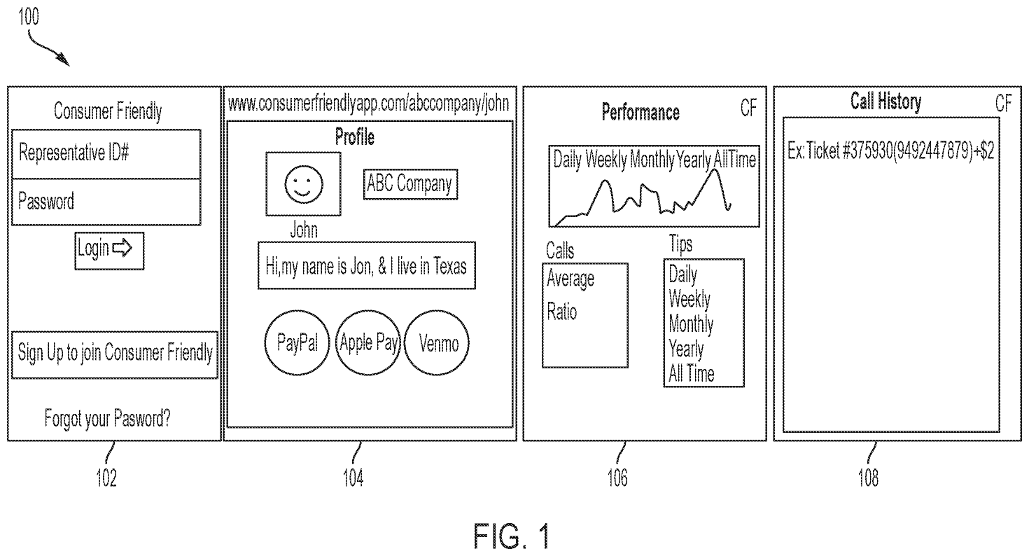

Further, it should be appreciated that modules and/or other appropriate means for performing the methods and techniques described herein, such as those illustrated by FIGS. 1-6, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

Embodiments described herein relate to a method and system for incentivizing and ranking customer service agents. Embodiments described below provide a software subscription service that offers a mechanism to customers to leave a tip for a customer service agent or representative following an interaction. Additional embodiments allow a subscribing company to monitor and rank customer service agents based on pre-selected metrics. Managers and individual customer service agents may also monitor performance using embodiments described herein.

Customer service agents may interact with a company's customers at various points in the purchase or delivery of products or services. A potential customer may call or “web chat” with a customer service agent to ask questions about a product or to make a reservation. Another interaction scenario may arise after purchase or delivery when a customer has a problem with the purchase, such as the product not working as expected, or there were problems with the delivery. In either case, customer service agents directly interact with customers and can affect customer perception of a company or its products. These representatives can “make or break” a customer's experience with the company and if poorly handled, lose a customer.

The customer service agents work under challenging conditions, often having long shifts responding to calls or web chat queries. Often these agents are paid minimum wage and work hours that are outside the typical workday and may include evenings, weekends, and holidays. In many cases, agent turnover is high, along with agent stress. Customers may also be unhappy with their interactions with these discouraged and unmotivated agents and may even decide not to purchase from the company again. Embodiments described herein provide a software subscription service that allows companies to incentivize customer service agents through tips left by satisfied customers. These embodiments send a message to a customer after interacting with a customer service agent and ask if the customer would like to leave a tip for the agent. The message includes a link to payment options for the agent.

A further embodiment provides tracking dashboards for the company to measure agent performance. Dashboards allow a company to view the number of agent calls and tipping ratio for all agents within the company, managers to view their team of agents tipping ratio, and individual agents to view their performance metrics. Agents and managers are provided with a clear view of how they are performing. These metrics allow managers to rank individual agents and to raise awareness of top performing agents.

Embodiments described herein provide a software subscription service that allows customers to leave tips for customer service agents or representatives and also provides tracking dashboards and metrics for subscribing companies to track and rank customer service agent performance. The software is provided using the mechanism of software as a service (SaaS).

SaaS is a software licensing and delivery model in which software is licensed on a subscription basis and is centrally hosted. It may be referred to as “on-demand software”. SaaS is typically accessed by clients through a thin client via a web browser. This delivery mechanism has become common with a wide variety of software applications delivered in this fashion, including office software, payroll software, messaging software, and customer relationship management, among just a few.

SaaS vendors develop and manage their own software distribution is straightforward. The SaaS model does not require physical distribution and is deployed quickly, through the subscription portal. SaaS providers often price applications using a subscription fee, which may be monthly or annual. This allows for lower cost initial setup. SaaS vendors may price applications based on usage parameters, such as the number of users using the application. This subscription parameter is one parameter that may be used by embodiments described herein. Additional embodiments contemplate charging per tip transaction, or other event, or unit of value.

SaaS architecture may use a multitenant architecture. With this architecture model, a single version of the application, with a single configuration (hardware, network, operating system) may be used for all customers. Scalability is supported by installing the application on multiple machines. A single customer, in this case a company, may alter the set of configuration options to suit their needs. These configuration options may affect functionality and look-and-feel of the application but do not affect the multitenant architecture. Each company may have its own settings for the configuration options, as described below. A subscriber company may wish to have its logo or brand displayed on the tipping page for the individual agent.

FIG. 1 illustrates a sign-up screen for a software as a service application (SaaS) to incentivize and rank customer service agents. A potential client company may be directed to the sign-up or log-in screen on the interface 100 screen upon accessing the SaaS website. The company interface screen may also be accessible to managers as well as individual customer service representative or agents. Screen interface 102 provides company sign-up or log-in entry. Each company subscribing to the service establishes an account with log-in credentials. As shown in 102, each representative of a subscriber company may also have log-in and password credentials that may allow access to agent screens, performance metric data, call and gratuity logs. Each representative may access a representative profile screen 104. This representative profile screen 104 may contain a photo as well as information about the representative, company, and may also contain at least one payment option for a customer to leave a tip.

Each individual representative or agent may also access a metrics page 106 after logging in to the SaaS application. Metrics page 106 may provide information over multiple time periods such as daily tips, weekly tips, monthly, yearly, and all-time tips. Metrics page 106 may provide this data in multiple formats, such as graphs, pie charts, bar charts, tables, and other means of displaying data metrics. Representatives may also access a call/gratuity log 108 that may provide information such as call ticket number, date, amount of tip, and the like. Alternative means of displaying the information are contemplated and are within the scope of this disclosure.

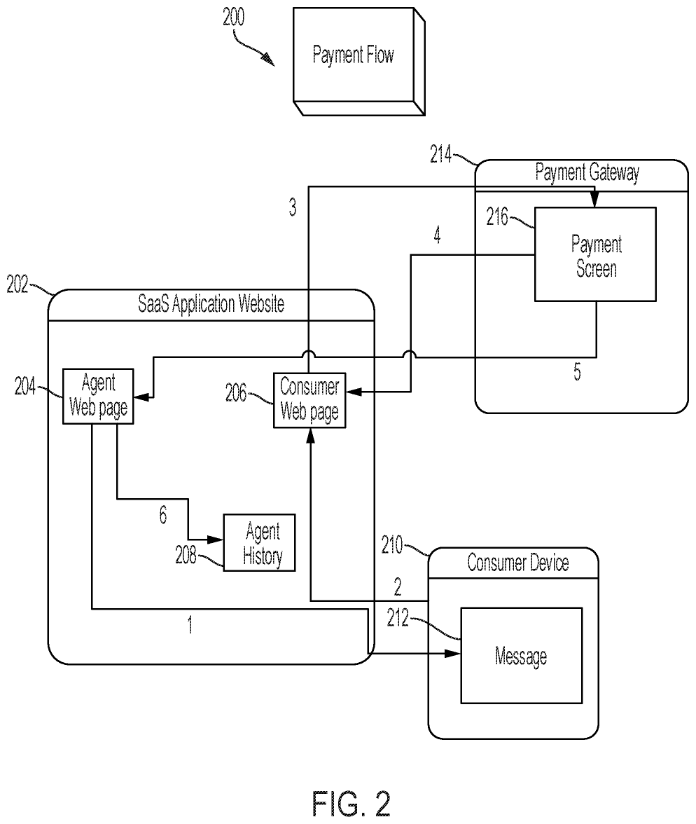

FIG. 2 shows the operation of the subscription service, in accordance with embodiments described herein. The payment flow 200 begins once the customer service representative has completed a customer interaction. In data flow 1 the customer service representative sends a message 212 from the SaaS application 202 to the consumer's device 210. Each time a message 212 is sent a unique link is generated by the SaaS application and this unique link is mapped by the SaaS application to the customer service representative and specific customer interaction. Message 212 may be a short message service (SMS) message, an email, or other type of message delivered electronically, such as a Twitter feed message. The message 212 is delivered to the customer's cell phone or other electronic device. The message 212 may also be incorporated into the customer interaction with the representative as the representative may ask if the customer would like to leave a tip or receive information about leaving a tip. Customers receiving a message 212 may initiate the tipping process by clicking on the link embedded within message 212. Once the customer clicks on the link in message 212 to leave a tip data flow 2 routes the customer to consumer web page 206. While on consumer web page 206 the customer determines the amount of tip to leave the customer service representative. Once the tip amount has been entered the customer is routed in data flow 3 to the payment gateway 214. Payment gateway 214 provides payment screen 216 which allows the customer to select an electronic payment method. Electronic payment methods may include PayPal, Apple Pay, Venmo or other similar electronic payment schemes. Payment gateway 214 responds by sending a success or failure message to the consumer web page 206 in data flow 4. Payment gateway 214 sends the tip amount to the SaaS application 202 in data flow 5. This tip value is mapped by the SaaS application to the customer service representative and the specific customer interaction that generated the tip. Payment gateway 214 may advise customers of the amount of the tip that will actually be received by the customer service representative and the transaction cost to provide the tip.

SaaS application 202 includes an agent web page 204 for each customer service representative of the subscribing company. This agent web page 204 receives data flow 5 from payment gateway 214. Data flow 5 contains the information on the tip value given by the customer in the mapped interaction. Each customer service interaction generates a unique link that is used throughout the payment flow process to directly tie a specific customer service interaction with a tip amount. Customer service interactions where a customer declines to leave a tip are recorded a $0 on the agent web page 204. The agent web page 204 sends tip amounts, including $0 tips in data flow 6 to an agent history log 208. The customer service representative, manager, and company leadership may view the agent history 208.

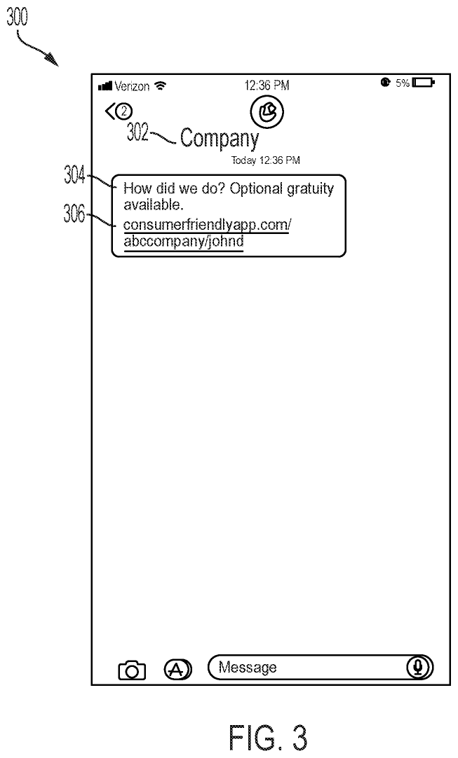

FIG. 3 depicts a message received by a customer following a customer service interaction. The message 300 may be a SMS message, or other message such as email. While SMS messages are used to illustrate operation of the SaaS application, the description herein is not limited to particular types of messages and any message deliverable to the customer may be used without departing from the spirit and scope of the application. Message 300 may include sender information 302 that may describe the company and/or the customer service representative. Message text 304 may include information or questions to the customer such as “How did we do?” as shown in FIG. 3. A link 306 is also included in message information 304. Link 306 routes the customer to the consumer web page 206 of the SaaS application 202, as described above. Some embodiments may provide for a link to expire within a pre-determined period of time, set by the subscribing company, in order to provide updates within a reasonable period of time. This may be needed as some customers may decline to reply at all to the tip message and without a reply some customer service interactions could remain open indefinitely.

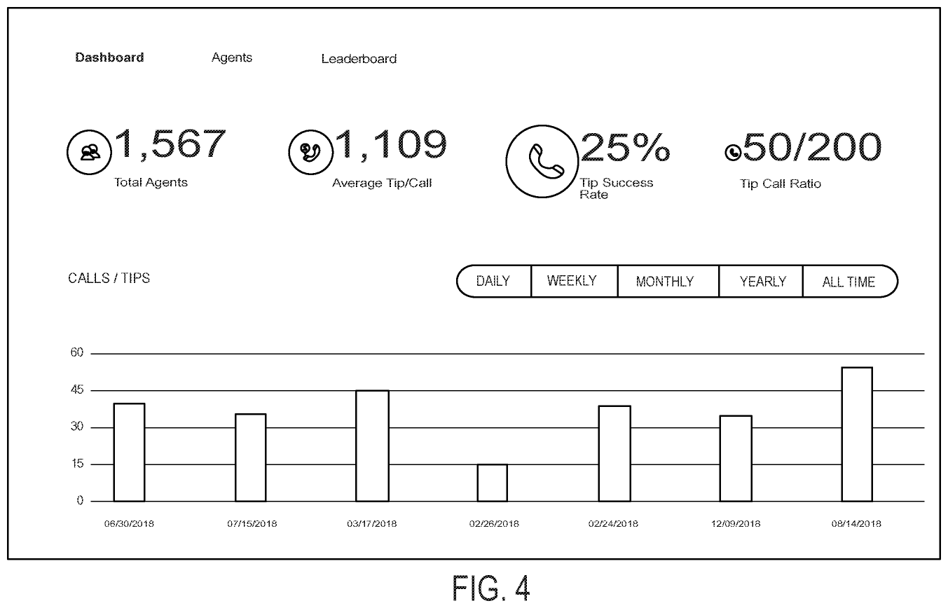

FIG. 4 shows a manager or supervisory dashboard for subscribing companies, in accordance with embodiments described herein. A manager or supervisor is provided with an overview of all customer service agents and data relative to performance for the representatives supervised. Performance information may include the average tip/call ratio, tip success rate, and tip/call ratio. The time period may be selected and may be selected from: daily, weekly, monthly, yearly, and all time. Bar graphs may also be incorporated and may show calls/tips for selected or specified dates. Using FIG. 4 a manager sees an overall view of the performance of customer service agents supervised.

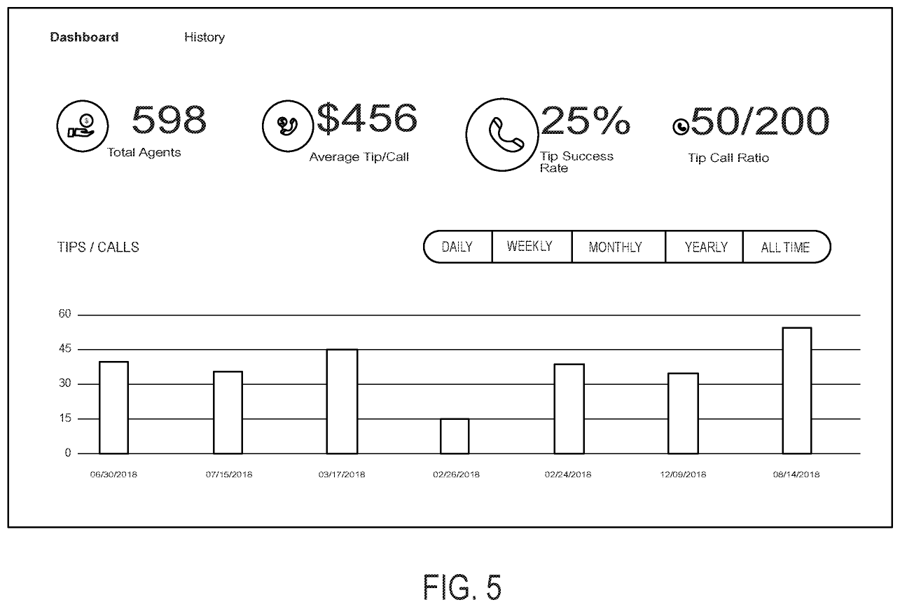

FIG. 5 illustrates a customer service agent dashboard for subscribing companies, in accordance with embodiments described herein. The customer service agent's dashboard or overview lists the number of agents reporting to a particular manager and provides individual performance data for the customer service agent. Each customer service agent has access to their unique dashboard so that each agent may track tips and effectiveness. Individual agents may be motivated to improve or continue providing good customer service as they see a direct benefit from the tips.

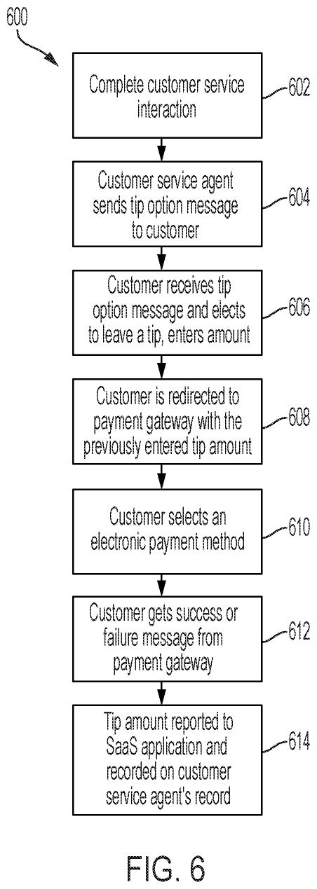

FIG. 6 is a flowchart of a method of incentivizing and ranking customer service agents, according to embodiments described herein. The method 600 begins when a customer service interaction is completed in step 602. This interaction may be a call, email exchange, visual cell phone call, internet call, live chat session, or any interaction with a named customer service agent. The customer service agent then sends a tip option message 604 to that customer. As described above in FIG. 3, the tip option message 604 contains a tip question 304 and a link 306 for the customer to leave a tip for the customer service agent. The link takes the customer to a tipping amount screen. If the customer decides to leave a tip in response to the tip message, then the customer enters the tip information on the screen. Next, in step 608 the customer is redirected to the payment gateway with the previously entered tip amount. The payment gateway may provide multiple options to allow the customer to select a particular electronic payment application or service. The customer then selects an electronic payment method in step 610. At this point, the selected electronic payment application processes the customer's tip and once processing is complete, sends either a success or failure message to the customer in step 612. The electronic payment processing application reports the tip amount and the customer service agent involved to the SaaS application, which records the tip amount in the record created for the particular customer service interaction.

Further embodiments provide for expiration of the tip option link in the message sent to the customer after a specified period of time. This allows the SaaS software to close customer service interaction records within a customer designated period of time, thus avoiding a plethora of open records.

A further embodiment allows ranking of customer service agents based on the tips generated within a desired period of time. The period of time used in the ranking may be varied based on the needs of the subscribing company. This ranking does not rely on subjective measures often found in post-interaction surveys, rather, the ranking is based on the amount or number of tips generated, an objective measure. The SaaS application may allow subscribing companies to pre-select a ranking time period, which may be adjusted at the conclusion of the time period.

A still further embodiment provides that the electronic payment options provided on the payment gateway may route tips directly to the agents, and not to the subscribing company. This embodiment may require customer service agents to set up and maintain payment accounts with multiple electronic payment providers. An alternative embodiment may route customer service agent tips through the subscribing company's electronic payment accounts with multiple electronic payment providers.

Further embodiments also contemplate that to encourage customers to leave tips a company may include incentives for customers. One embodiment may provide that a customer leaving a tip receive additional rewards points in the company's loyalty or incentive program. Points may be used to decrease waiting time and a subscribing company may elect to have points be redeemable in multiple ways. To give just one example, a customer leaving five tips may be offered a discount on further purchases after the fifth tip is given. The tipping targets may be varied by the subscribing companies with varying totals needed for successive loyalty rewards. Further embodiments may provide that customers with a generous tip history be routed to specific high-performing agents or receive enhanced loyalty points, with selection by the customer possible. Subscribing companies may also rank customers according to a number of possible parameters, including tip frequency and size.

It is understood that the specific order or hierarchy of blocks in the processes disclosed is an illustration of exemplary approaches. Based upon design preferences, it is understood that the specific order or hierarchy of blocks in the processes may be rearranged. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for tipping and ranking customer service agents, comprising:
completing a customer service interaction;
sending a tip option message to a customer that participated in the customer service interaction;
receiving a response to the tip option message from the customer;
redirecting the customer to a payment gateway if a tip amount is entered in the tip option message;
receiving the tip amount from the payment gateway;
recording the tip amount in a customer service agent record; and
ranking customer service agents based on the customer service agent record.

2. The method of claim 1, wherein the tip option message expires after a pre-determined period of time.

3. The method of claim 1, wherein the payment gateway contains at least one electronic payment application.

4. The method of claim 2, wherein the payment gateway reports a zero tip amount upon expiration of the tip option message.

5. The method of claim 1, wherein the tip is provided directly to the customer service agent by a selected electronic payment application.

6. The method of claim 1, wherein the tip is provided to the subscribing company and directed by the subscribing company to the customer service agent involved in the customer service interaction.

7. The method of claim 1, wherein the ranking of customer service agents based on the customer service agent record is performed based on a selected period of time.

8. An apparatus for tipping and ranking customer service agents, comprising:
means for completing a customer service interaction;
means for sending a tip option message to a customer that participated in the customer service interaction;
means for receiving a response to the tip option message from the customer;
means for redirecting the customer to a payment gateway if a tip amount is entered in the tip option message;
means for receiving the tip amount from the payment gateway;
means for recording the tip amount in a customer service agent record; and
means for ranking customer service agents based on the customer service agent record.

9. The apparatus of claim 8, wherein the means for receiving a response to the tip option message includes means for expiration of the tip option message after a pre-determined amount of time.

10. The apparatus of claim 8, wherein the means for receiving the tip amount from the payment gateway includes means for receiving the tip amount from multiple electronic payment applications.

11. The apparatus of claim 8, further comprising means for selecting from multiple electronic payment applications.

12. The apparatus of claim 9, wherein the means for receiving a response to the tip option message reports a zero tip amount if the tip option message expires.

13. The apparatus of claim 8, wherein the means for receiving the tip amount from the payment gateway delivers the tip amount to the customer service agent.

14. The apparatus of claim 8, wherein the means for receiving the tip amount from the payment gateway delivers the tip amount to a subscribing company.

15. A non-transitory computer-readable medium containing instructions, which when executed by a processor cause a processor to perform the steps of:
sending a tip option message to a customer that participated in a completed customer service interaction;
receiving a response to the tip option message from the customer;
redirecting the customer to a payment gateway if a tip amount is entered in the tip option message;
receiving the tip amount from the payment gateway;
recording the tip amount in a customer service agent record; and
ranking customer service agents based on the customer service agent record.

16. The non-transitory computer-readable medium of claim 15, wherein the instructions for sending a tip option message to a customer that participated in a completed customer service interaction include instructions that cause the tip option message to expire after a pre-determined amount of time.

17. The non-transitory computer-readable medium of claim 15, wherein the payment gateway contains multiple electronic payment applications.

18. The non-transitory computer-readable medium of claim 15, wherein the instructions for recording the tip amount in a customer service agent record contain instructions for recording a zero tip amount if the tip option message expires without customer input.

19. The non-transitory computer-readable medium of claim 15, wherein the instructions for ranking customer service agents based on the customer service agent record is based on ranking results for a particular period of time.

20. The non-transitory computer-readable medium of claim 19, wherein the particular period of time is selected by a subscribing company.
